(19) United States
(12) Patent Application Publication
(10) Pub. No.: US 2005/0137284 A1
(43) Pub. Date: Jun. 23, 2005

(54) Inkjet ink and method for manufacturing same

(75) Inventors: Hidemasa Sawada, Nagoya-shi (JP); Takashi Kawaguchi, Nagoya-shi (JP); Akiko Mizuno, Nagoya -shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 11/002,466

(22) Filed: Dec. 3, 2004

(30) Foreign Application Priority Data
Dec. 11, 2003 (JP) 2003-413459

(51) Int. Cl. C09D 11/02; C03C 17/00

(52) U.S. Cl. 523/160; 106/31.86; 106/31.65; 523/161

(57) ABSTRACT

The present invention provides an inkjet ink containing a pigment as its colorant, with which dryability on the recording medium is improved, bleeding of a printed matter is suppressed, and quality is improved. The inkjet ink further contains an aqueous medium, an aqueous emulsion, and a low-volatility solvent, wherein the low-volatility solvent contains the following components (a) and (b): component (a) diethylene glycol; and component (b) at least one type selected from the group consisting of propylene glycol monobutyl ether, propylene glycol monopropyl ether, dipropylene glycol monobutyl ether, dipropylene glycol monopropyl ether, and tripropylene glycol monobutyl ether.

### BACKGROUND OF THE INVENTION

1. Field of the Invention

The present invention relates to an inkjet ink with improved dryability and reduced bleeding, and to a method for manufacturing this ink.

2. Description of the Related Art

Inkjet inks used in the past for inkjet recording have generally been the product of dispersing a water-soluble dye as a colorant in an aqueous medium, but more recently pigment inks that make use of a pigment rather than a water-soluble dye have come into use because of their better resistance to weather and water.

Meanwhile, some of the problems encountered in inkjet recording include (1) bleeding of the ink on the recording medium, (2) tailing caused by slow drying of the ink on the recording medium, and (3) printing defects caused by clogging of the inkjet head nozzles. Many different measures have been proposed for dealing with these problems, such as adding a surfactant so as to lower the surface tension of the ink and thereby increase the rate at which the ink permeates into the recording medium, or adding a high-boiling, low-volatility solvent so as to suppress the drying of the ink in the nozzles. For example, Japanese Patent 3,097,103 discloses the addition of glycerol and a microemulsion to a dispersion obtained by dispersing a pigment in an aqueous medium.

### SUMMARY OF THE INVENTION

It is an object of the present invention to provide an inkjet ink containing a pigment as its colorant, with which dryability on the recording medium is improved, bleeding is suppressed, and the quality of the printed matter is improved, and more particularly to allow the formation of a high-quality image, with no bleeding even when printing on fabric.

The present inventors discovered that the dryability of an ink on a recording medium can be increased and bleeding prevented by adding an aqueous emulsion and a special low-volatility solvent to a dispersion obtained by dispersing a pigment in an aqueous medium.

Specifically, the present invention is an inkjet ink containing a pigment, an aqueous medium, an aqueous emulsion, and a low-volatility solvent, wherein said low-volatility solvent contains the following component (a) and component (b):

component (a) diethylene glycol; and

component (b) at least one selected from the group consisting of propylene glycol monobutyl ether, propylene glycol monopropyl ether, dipropylene glycol monobutyl ether, dipropylene glycol monopropyl ether, and tripropylene glycol monobutyl ether.

The present invention also provides a method for manufacturing an inkjet ink, comprising a first step of dispersing a pigment in an aqueous medium, and a second step of adding an aqueous emulsion and a low-volatility solvent to the dispersion obtained in the first step, wherein said low-volatility solvent contains the following components (a) and (b):

component (a) diethylene glycol; and

component (b) at least one selected from the group consisting of propylene glycol monobutyl ether, propylene glycol monopropyl ether, dipropylene glycol monobutyl ether, dipropylene glycol monopropyl ether, and tripropylene glycol monobutyl ether.

The inkjet ink of the present invention is obtained by adding an aqueous emulsion and a low-volatility solvent to a dispersion obtained by dispersing a pigment in an aqueous medium, wherein said the low-volatility solvent contains the following components (a) and (b):

component (a) diethylene glycol; and

component (b) at least one selected from the group consisting of propylene glycol monobutyl ether, propylene glycol monopropyl ether, dipropylene glycol monobutyl ether, dipropylene glycol monopropyl ether, and tripropylene glycol monobutyl ether. The diethylene glycol of component (a) prevents the ink from drying in the nozzles of the inkjet head, and also functions as a protectant for the aqueous emulsion. Accordingly, the diethylene glycol of component (a) stabilizes the aqueous emulsion, improves the dispersal of the pigment in the ink, and allows the ink to be fixed to the recording medium without bleeding.

Also, with the inkjet ink of the present invention, a special ether compound is added as component (b) along with the diethylene glycol of component (a), which further increases the dryability of the ink on the recording medium and prevents bleeding. Accordingly, with this inkjet ink, a sharp image can be obtained, with no bleeding even when inkjet recording is performed on fabric.

With the method of the present invention for manufacturing an inkjet ink, it is possible to manufacture an inkjet ink with which dryability on the recording medium is increased and bleeding is prevented.

### DESCRIPTION OF THE PREFERRED EMBODIMENTS

The present invention will now be described in detail.

The inkjet ink of the present invention contains a pigment, an aqueous medium, an aqueous emulsion, and a special low-volatility solvent.

There are no particular restrictions on the pigment here, and any inorganic or organic pigment that has been used in inkjet inks in the past can be used. Examples of organic pigments include azo pigment such as azo lake, insoluble azo pigment, condensed azo pigment, and chelate azo pigment; polycyclic pigment such as phthalocyanine pigment, perylene pigment, anthraquinone pigment, quinacridone pigment, dioxazine pigment, thioindigo pigment, isoindolinone pigment, and quinophthalone pigment; and dye lake such as basic reactive dye type lake and acidic reactive dye type lake; nitro pigment and nitroso pigment; aniline black; and daylight fluorescent pigments. Examples of inorganic pigments include titanium oxide, iron oxide, and carbon black. In terms of being able to express particularly vivid hues, it is preferable to use C.I. Pigment Yellow 3, 4, 5, 7, 17, 50, 51, 81, 98, 105, 180, or the like as a yellow pigment, to use C.I. Pigment Red 2, 3, 5, 16, 23, 31, 49, 57, 63, 122, or the like as a magenta pigment, and to use C.I. Pigment Blue 1, 2, 15:3, 16, 17, or the like as a cyan pigment.

If the particle size of the pigment is too small, print density, hiding power, pigment dispersion stability, and so forth will suffer, and if the particle size is too large, the inkjet head will be prone to clogging, and the vividness of color of the ink, pigment dispersion stability, and so forth will suffer, so the average volumetric particle size is preferably from 50 to 200 nm.

In terms of maintaining good dispersibility in the ink, the reproducibility of color density, and so forth, it is preferable for the pigment to be contained in an amount of 0.5 to 15 wt %.

The aqueous emulsion is added as a pigment dispersant, or as a binder for fixing the pigment to fabric, and any aqueous resin emulsion that has been used in conventional inkjet inks can be used. Examples of resins used to form such resin emulsions include acrylic resin emulsions, styrene/maleic anhydride copolymer resin emulsions, urethane resin emulsions, vinyl acetate resin emulsions, vinyl acetate/acrylic copolymer resin emulsions, and vinyl acetate/ethylene copolymer resin emulsions.

There are no particular restrictions on the properties of the aqueous emulsion, and it can be anionic, cationic, nonionic, etc. Also, it may be a microemulsion, a gloss emulsion, a reaction type emulsion, an emulsion that crosslinks at normal temperature, an emulsion with a two-layer structure, or the like.

In terms of the dispersibility of the resin emulsion in the ink, aiding reproduction of color density, and relaxing interaction with other ink components, it is preferable for the aqueous emulsion to be contained in an amount of 0.01 to 90 wt %, and particularly 0.1 to 50 wt %, and it is preferable for the average volumetric particle size of the resin microparticles that make up the emulsion to be 10 to 100 nm, and particularly 10 to 50 nm.

In the context of an inkjet ink, “low-volatility solvent” refers to a solvent that has a high boiling point and low volatility in comparison with water. Glycerol and other such low-volatility solvents with a high boiling point and low volatility in comparison with water have been used in the past to prevent drying in the nozzles of an inkjet head, but in the present invention the following component (a) and component (b) are used as essential components as this low-volatility solvent:

component (a) diethylene glycol; and

component (b) at least one selected from the group consisting of propylene glycol monobutyl ether, propylene glycol monopropyl ether, dipropylene glycol monobutyl ether, dipropylene glycol monopropyl ether, and tripropylene glycol monobutyl ether.

The ether compounds of component (b) may be used singly or as a combination of two or more types.

Adding both of the components (a) and (b) markedly improves the dryability of an ink and prevents it from bleeding, and also prevents the clogging of the nozzles in an inkjet head.

The amounts in which component (a) and component (b) are contained in the ink are preferably 0.01 to 80 wt % for component (a) and 0.01 to 30 wt % for component (b). The effects of the present invention will not be obtained if these amounts are too small, but it is undesirable for the amount of component (a) to be too large because it will result in higher viscosity and printing defects, while it is undesirable for the amount of component (b) to be too large because the hydrophilicity of a pigment dispersion medium will decrease, and the dispersibility of the pigment will decrease.

Pure water, ion exchange water, a water-soluble organic solvent, or the like can be used as the aqueous medium.

Here, a water-soluble organic solvent is used as needed in addition to the above-mentioned components (a) and (b), and examples include C₁ to C₄ alkyl alcohols, ketones or ketoalcohols, ethers, polyalkylene glycols, alkylene glycols whose alkylene group includes 2 to 6 carbons, glycerol, lower alkyl ethers of polyhydric alcohols, N-methyl-2-pyrrolidone, and triethanolamine.

The inkjet ink of the present invention can also contain additives such as dispersants (such as a water-soluble polymer), surfactants, pH adjusters, anti-foaming agents, and preservatives.

The method of the present invention for manufacturing an inkjet ink preferably comprises a first step of dispersing a pigment in an aqueous medium, and a second step of adding an aqueous emulsion and the above-mentioned component (a) and component (b) to the dispersion obtained in the first step.

In the first step, the pigment and an aqueous medium are dispersed using a ball mill, bead mill, sand mill, attritor, roll mill, agitator mill, Henschel mixer, colloid mill, ultrasonic homogenizer, per mill, jet mill, Angmill, or Mecafusion (made by Hosokawa Micron) pulverizer or disperser. Coarse particles are removed as needed by centrifugation, filtration, or the like to obtain a pigment dispersion.

In the second step, an aqueous emulsion and the above-mentioned components (a) and (b) are added to the pigment dispersion obtained in the first step, uniformly dispersed by stirring, and filtered as needed to obtain an ink.

Any additives are preferably added in the second step as needed.

The inkjet ink obtained in this manner can be used in a piezo inkjet printer that makes use of piezoelectric elements for the printer head. The image formed on the recording medium with the inkjet printer is preferably fixed to the recording medium by performing a heat treatment with a heat roll, a heat treatment by blowing hot air onto the medium, a steam heat treatment, or another such heat treatment.

Examples of recording media that can be used for inkjet recording with this ink include plain paper, special paper, and other types of paper; woven fabric, knit fabric, nonwoven cloth, and other types of fabric; and wood and cardboard. There are no particular restrictions on the fibers that make up the fabric, but examples include cotton, silk, flax, wool, and other such natural fibers; polyamide, polyester, acrylic, and other such synthetic fibers; rayon, acetate, and other such regenerated and semi-synthetic fibers; and blends of these fibers. An example of a recording medium that is favorable in terms of feel, water absorbency, price, ready availability, and so on is 100% cotton, white T-shirt material.

### EXAMPLES

### Examples 1 to 5, Comparative Example 1

(1) Preparation of Ink

Inks with the compositions shown in Table 1 were prepared. These inks were prepared by the following method. First, a pigment and ion exchange water were stirred and dispersed for at least 30 minutes in a dispersing machine (sand grinder made by Igarashi Kikai). To this were added an aqueous emulsion, the diethylene glycol of component (a), and component (b) (Examples 1 to 5), or an aqueous emulsion and glycerol (Comparative Example 1). The system was stirred for 5 minutes, and this dispersion was pressure filtered through a 3 μm membrane filter or a 5 μm metal filter.

TABLE 1

| | Examples | Comparative |
|---|---|---|
| | 1 to 5 | Example 1 |
| Pigment (*1) | 6 wt % | 6 wt % |
| Aqueous emulsion (*2) | 6 wt % | 6 wt % |
| Diethylene glycol | 13 wt % | — |
| Component (b) from Table 2 | 3 wt % | — |
| Glycerol | — | 16 wt % |
| Ion exchange water | balance | balance |

*1 Carbon black: MA100 made by Mitsubishi Kasei
*2 Acrylic resin emulsion adjusted to a pH of 8 to 10

TABLE 2

| | | OD | | Dryability |
|---|---|---|---|---|
| | Component (b) | value | Bleeding | (sec) |
| Example 1 | propylene glycol | 1.00 | good | 0 |
| | monobutyl ether | | | |
| Example 2 | propylene glycol | 0.97 | good | 0 |
| | monopropyl ether | | | |
| Example 3 | dipropylene glycol | 1.02 | good | 0 |
| | monobutyl ether | | | |
| Example 4 | dipropylene glycol | 0.94 | good | 0 |
| | monopropyl ether | | | |
| Example 5 | tripropylene glycol | 1.03 | good | 0 |
| | monobutyl ether | | | |
| Comarative | — | 0.85 | poor | 15 |
| Example 1 | | | | |

(2) Evaluation

Each ink obtained in (1) was evaluated as follows for (2-1) recording density of printed image, (2-2) bleeding, and (2-3) dryability. The results are shown in Table 2.

(2-1) Recording Density

The inks of the examples and comparative examples obtained in (1) were each set in a piezo type of inkjet printer with a resolution of 600 dpi, a 100% cotton T-shirt (beefy-T made by Hanes) was printed with a solid black image, and the recording density (OD value) was measured with a densitometer (Macbeth RD-914).

(2-2) Bleeding

The inks of the examples and comparative examples and a yellow ink for use in water-based inkjet printing were each set in a piezo type of inkjet printer with a resolution of 600 dpi, a 100% cotton T-shirt (beefy-T made by Hanes) was printed with straight lines 1 mm in width using the inks of the examples and comparative examples against solid yellow printing. The printing was judged to be good when the width of the straight lines was no more than 1.2 times a specific width, and poor when over 1.2 times.

(2-3) Dryability

The inks of the examples and comparative examples were each set in a piezo type of inkjet printer with a resolution of 600 dpi, a 100% cotton T-shirt (beefy-T made by Hanes) was printed a number of lines in a pattern that took 1 second for each line of pattern. Immediately after this printing, the printed surface was rubbed with a finger from the line printed last toward the line printed first, the number of lines where the printed image bled were counted, and it was noted how long it took until no more bleeding occurred from immediately after printing.

It can be seen from the results in Table 2 that with all of the inks of Examples 1 to 5 the recording density was higher, there was no bleeding, and the dryability was superior as compared to the ink of Comparative Example 1.

The ink of the present invention can be used to perform inkjet recording on a variety of recording media, including fabric.

The entire disclosure of the specification, summary and claims of Japanese Patent Application No. 2003-413459 filed on Dec. 11, 2003 is hereby incorporated by reference.

1. An inkjet ink containing a pigment, an aqueous medium, an aqueous emulsion, and a low-volatility solvent, wherein said low-volatility solvent contains the following components (a) and (b):
component (a) diethylene glycol; and
component (b) at least one type selected from the group consisting of propylene glycol monobutyl ether, propylene glycol monopropyl ether, dipropylene glycol monobutyl ether, dipropylene glycol monopropyl ether, and tripropylene glycol monobutyl ether.

2. The inkjet ink according to claim 1, wherein component (a) is contained in an amount of 0.01 to 80 wt % and component (b) 0.01 to 30 wt %.

3. The inkjet ink according to claim 1, wherein the pigment is contained in an amount of 0.5 to 15 wt %.

4. The inkjet ink according to claim 1, wherein the aqueous emulsion is contained in an amount of 0.01 to 90 wt %.

5. The inkjet ink according to claim 1, wherein the aqueous emulsion contains resin microparticles, of which the average volumetric particle size is 10 to 100 nm.

6. A method for manufacturing an inkjet ink, comprising a first step of dispersing a pigment in an aqueous medium, and a second step of adding an aqueous emulsion and a low-volatility solvent to the dispersion obtained in the first step, wherein said low-volatility solvent contains the following components (a) and (b):
component (a) diethylene glycol; and
component (b) at least one type selected from the group consisting of propylene glycol monobutyl ether, propylene glycol monopropyl ether, dipropylene glycol monobutyl ether, dipropylene glycol monopropyl ether, and tripropylene glycol monobutyl ether.

7. The method for manufacturing an inkjet ink according to claim 6, wherein component (a) is contained in an amount of 0.01 to 80 wt % and component (b) 0.01 to 30 wt % in the inkjet ink.

8. The method for manufacturing an inkjet ink according to claim 6, wherein the pigment is contained in an amount of 0.5 to 15 wt % in the inkjet ink.

9. The method for manufacturing an inkjet ink according to claim 6, wherein the aqueous emulsion is contained in an amount of 0.01 to 90 wt % in the inkjet ink.

10. The method for manufacturing an inkjet ink according to claim 6, wherein the aqueous emulsion contains resin microparticles, of which the average volumetric particle size is 10 to 100 nm.
